(19) United States
(12) Patent Application Publication
(10) Pub. No.: US 2004/0042665 A1
(43) Pub. Date: Mar. 4, 2004

(54) Method and computer program product for automatically establishing a classifiction system architecture

(75) Inventors: David L. Il, Owego, NY (US); Elliott D. Reitz II, Bradenton, FL (US); Dennis A. Tillotson, Glen Aubrey, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/232,074

(22) Filed: Aug. 30, 2002

(51) Int. Cl. G06K 9/62

(52) U.S. Cl. 382/225

(57) ABSTRACT

A method and computer program product is disclosed for automatically establishing a system architecture for a pattern recognition system with a plurality of output classes. Feature data is extracted from a plurality of pattern samples corresponding to a selected set of feature variables. A clustering algorithm is then applied to the extracted feature data to identify a plurality of clusters, including at least one cluster containing more than one output class. The identified clusters are arranged into a first level of classification that discriminates between the clusters using the selected set of feature variables. Finally, the output classes within each cluster containing more than one output class are arranged into at least one sublevel of classification that discriminates between the output classes within the cluster using at least one alternate set of feature variables.

### BACKGROUND OF THE INVENTION

1. Technical Field

The invention relates to a system for automatically establishing a classification architecture for a pattern recognition device or classifier. Image processing systems often contain pattern recognition devices (classifiers).

2. Description of the Prior Art

Pattern recognition systems, loosely defined, are systems capable of distinguishing between various classes of real world stimuli according to their divergent characteristics. A number of applications require pattern recognition systems, which allow a system to deal with unrefined data without significant human intervention. By way of example, a pattern recognition system may attempt to classify individual letters to reduce a handwritten document to electronic text. Alternatively, the system may classify spoken utterances to allow verbal commands to be received at a computer console. In order to classify real-world stimuli, however, it is necessary to train the classifier to discriminate between classes by exposing it to a number of sample patterns.

The performance of any classifier depends heavily on the characteristics, or features, used to discriminate between the classes. Features that vary significantly across a set of output classes allow for accurate discrimination among the classes. Where a set of classes do not vary appreciably across a particular set of features, they are said to be poorly separated in feature space. In such a case, accurate classification will be resource intensive or impossible without resort to alternate or additional features. Accordingly, a method of identifying groups of classes that are poorly separated in feature space and arranging the classification system to better distinguish among them would be desirable.

### SUMMARY OF THE INVENTION

The present invention recites a method of automatically establishing a system architecture for a pattern recognition system with a plurality of output classes. Feature data is extracted from a plurality of pattern samples corresponding to a selected set of feature variables. A clustering algorithm is then applied to the extracted feature data to identify a plurality of clusters, including at least one cluster containing more than one output class.

The identified clusters are arranged into a first level of classification that discriminates between the clusters using the selected set of feature variables. Finally, the output classes within each cluster containing more than one output class are arranged into at least one sublevel of classification that discriminates between the output classes within the cluster using at least one alternate set of feature variables.

In accordance with another aspect of the present invention, a computer program product is disclosed for automatically establishing a system architecture for a pattern recognition system with a plurality of output classes. A feature extraction portion extracts feature data from a plurality of pattern samples corresponding to a selected set of feature variables. A clustering portion then applies a clustering algorithm to the extracted feature data to identify a plurality of clusters, including at least one cluster containing more than one output class.

An architecture organization portion arranges the identified clusters into a first level of classification that discriminates between the clusters using the selected set of feature variables. The architecture organization portion then arranges the output classes within each cluster containing more than one output class into at least one sublevel of classification that discriminates between the output classes within the cluster using at least one alternate set of feature variables.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is an illustration of an exemplary neural network utilized for pattern recognition;

FIG. 2 is a functional diagram of a classifier compatible with the present invention;

FIG. 3 is a flow diagram illustrating the training of a classifier compatible with the present invention;

FIG. 4 is a flow diagram illustrating the run-time operation of the present invention;

FIG. 5 is a schematic diagram of an example embodiment of the present invention in the context of a postal indicia recognition system.

### DETAILED DESCRIPTION OF THE INVENTION

In accordance with the present invention, a method for automatically establishing a system architecture for a pattern recognition classifier is described. The method may be applied to classifiers used in any traditional pattern recognition classifier task, including, for example, optical character recognition (OCR), speech translation, and image analysis in medical, military, and industrial applications.

It should be noted that a pattern recognition classifier to which the present invention may be applied will typically be implemented as a computer program, preferably a program simulating, at least in part, the functioning of a neural network. Accordingly, understanding of the present invention will be facilitated by an understanding of the operation and structure of a neural network.

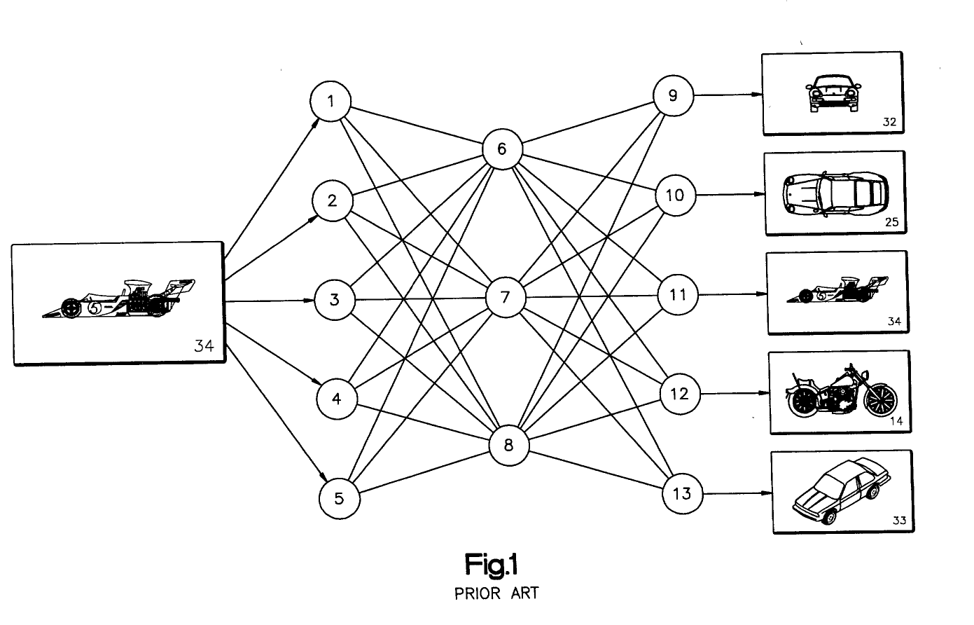

FIG. 1 illustrates a neural network that might be used in a pattern recognition task. The illustrated neural network is a three-layer back-propagation neural network used in a pattern classification system. It should be noted here that the neural network illustrated in FIG. 1 is a simple example solely for the purposes of illustration. Any nontrivial application involving a neural network, including pattern classification, would require a network with many more nodes in each layer. In addition, additional hidden layers might be required.

In the illustrated example, an input layer comprises five input nodes, 1-5. A node, generally speaking, is a processing unit of a neural network. A node may receive multiple inputs from prior layers which it processes according to an internal formula. The output of this processing may be provided to multiple other nodes in subsequent layers. The functioning of nodes within a neural network is designed to mimic the function of neurons within a human brain.

Each of the five input nodes 1-5 receives input signals with values relating to features of an input pattern. By way of example, the signal values could relate to the portion of an image within a particular range of grayscale brightness. Alternatively, the signal values could relate to the average frequency of an audio signal over a particular segment of a recording. Preferably, a large number of input nodes will be used, receiving signal values derived from a variety of pattern features.

Each input node sends a signal to each of three intermediate nodes 6-8 in the hidden layer. The value represented by each signal will be based upon the value of the signal received at the input node. It will be appreciated, of course, that in practice, a classification neural network may have a number of hidden layers, depending on the nature of the classification task.

Each connection between nodes of different layers is characterized by an individual weight. These weights are established during the training of the neural network. The value of the signal provided to the hidden layer by the input nodes is derived by multiplying the value of the original input signal at the input node by the weight of the connection between the input node and the intermediate node. Thus, each intermediate node receives a signal from each of the input nodes, but due to the individualized weight of each connection, each intermediate node receives a signal of different value from each input node. For example, assume that the input signal at node 1 is of a value of 5 and the weights of the connections between node 1 and nodes 6-8 are 0.6, 0.2, and 0.4 respectively. The signals passed from node 1 to the intermediate nodes 6-8 will have values of 3, 1, and 2.

Each intermediate node 6-8 sums the weighted input signals it receives. This input sum may include a constant bias input at each node. The sum of the inputs is provided into a transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes 6-8 pass a signal with the computed output value to each of the nodes 9-13 of the output layer. An individual intermediate node (i.e. 7) will send the same output signal to each of the output nodes 9-13, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node represents the probability that a given input sample belongs to the associated class. In the example system, the class with the highest associated probability is selected, so long as the probability exceeds a predetermined threshold value. The value represented by the output signal is retained as a confidence value of the classification.

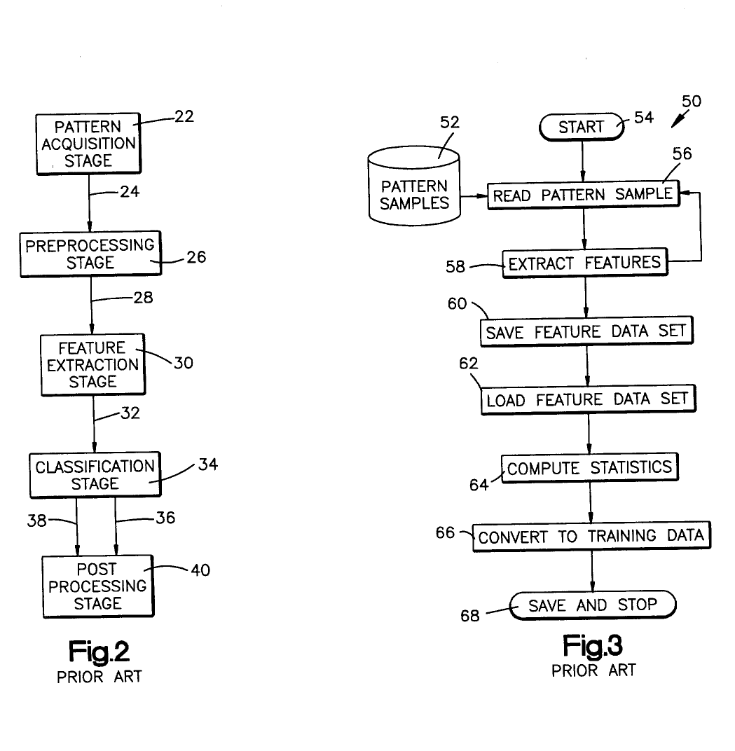

FIG. 2 illustrates a classification system 20 that might be used in association with the present invention. As stated above, the present invention and any associated classification system will likely be implemented as software programs. Therefore, the structures described hereinafter may be considered to refer to individual modules and tasks within these programs.

Focusing on the function of a classification system 20 compatible with the present invention, the classification process begins at a pattern acquisition stage 22 with the acquisition of an input pattern. The pattern 24 is then sent to a preprocessing stage 26, where the pattern 24 is preprocessed to enhance the image, locate portions of interest, eliminate obvious noise, and otherwise prepare the pattern for further processing.

The selected portions of the pattern 28 are then sent to a feature extraction stage 30. Feature extraction converts the pattern 28 into a vector 32 of numerical measurements, referred to as feature variables. Thus, the feature vector 32 represents the pattern 28 in a compact form. The vector 32 is formed from a sequence of measurements performed on the pattern. Many feature types exist and are selected based on the characteristics of the recognition problem.

The extracted feature vector 32 is then provided to a classification stage 34. The classification stage 34 relates the feature vector 32 to the most likely output class, and determines a confidence value 36 that the pattern is a member of the selected class. This is accomplished by a statistical or neural network classifier. Mathematical classification techniques convert the feature vector input to a recognition result 38 and an associated confidence value 36. The confidence value 36 provides an external ability to assess the correctness of the classification. For example, a classifier output may have a value between zero and one, with one representing maximum certainty.

Finally, the recognition result 38 is sent to a post-processing stage 40. The post-processing stage 30 applies the recognition result 38 provided by the classification stage 34 to a real-world problem. By way of example, in a postal indicia recognition system, the post-processing stage might keep track of the revenue total from the classified postal indicia.

FIG. 3 is a flow diagram illustrating the operation of a computer program 50 used to train a pattern recognition classifier via computer software. A number of pattern samples 52 are collected or generated. The number of pattern samples necessary for training varies with the application. The number of output classes, the selected features, and the nature of the classification technique used directly affect the number of samples needed for good results for a particular classification system. While the use of too few images can result in an improperly trained classifier, the use of too many samples can be equally problematic, as it can take too long to process the training data without a significant gain in performance.

The actual training process begins at step 54 and proceeds to step 56. At step 56, the program retrieves a pattern sample from memory. The process then proceeds to step 58, where the pattern sample is converted into a feature vector input similar to those a classifier would see in normal run-time operation. After each sample feature vector is extracted, the results are stored in memory, and the process returns to step 56. After all of the samples are analyzed, the process proceeds to step 60, where the feature vectors are saved to memory as a set.

The actual computation of the training data begins in step 62, where the saved feature vector set is loaded from memory. After retrieving the feature vector set, the process progresses to step 64. At step 64, the program calculates statistics, such as the mean and standard deviation of the feature variables for each class. Intervariable statistics may also be calculated, including a covariance matrix of the sample set for each class. The process then advances to step 66 where it uses the set of feature vectors to compute the training data. At this step in an example embodiment, an inverse covariance matrix is calculated, as well as any fixed value terms needed for the classification process. After these calculations are performed, the process proceeds to step 68 where the training parameters are stored in memory and the training process ends.

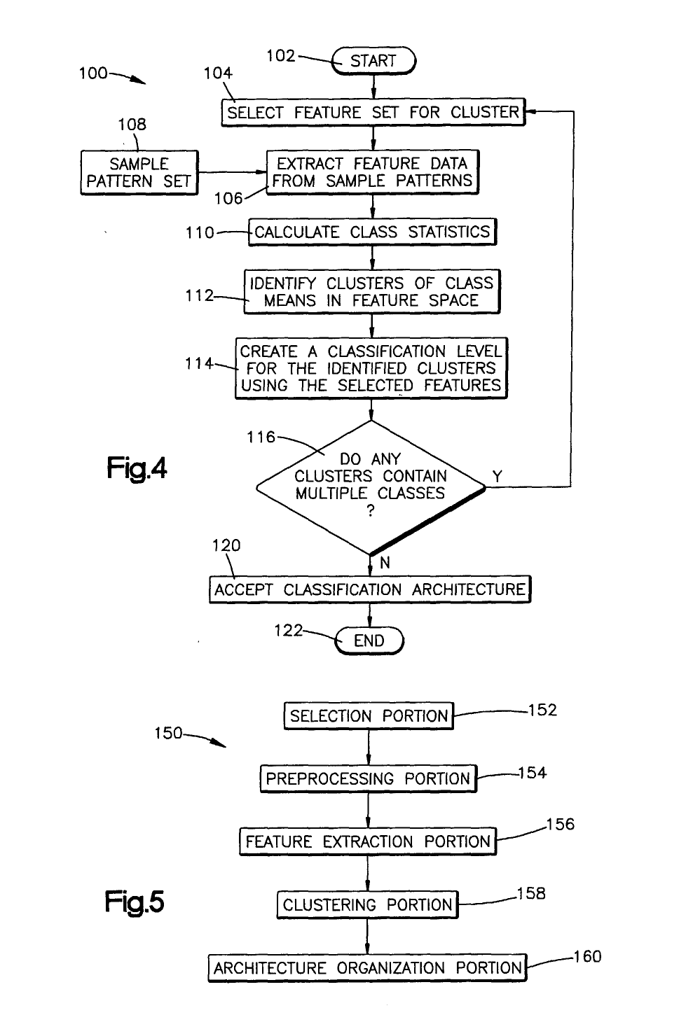

FIG. 4 illustrates the run-time operation of the present invention. The process 100 begins at step 102. The process then advances to step 104, where a feature set is selected for the cluster presently being organized. If this is the first iteration of the program, the cluster will naturally consist of all output classes represented by the classifier. Feature selection can be accomplished by a number of means, including, human selection, automated selection processes, or even simple trial and error. After an appropriate feature set is selected, the process proceeds to step 106.

At step 106, the system extracts feature data from a set of sample patterns 108. The process continues at step 110, where this feature data is used to calculate class statistics. Single variable statistics such as the mean, standard deviation, and the range may be calculated, as well as multivariate statistics such as interclass covariances. The process continues at step 112, where the system performs a clustering analysis on the statistical data and identifies clusters of classes that are poorly separated in feature space. A number of clustering algorithms are available for this purpose, including Ward's method, k-means analysis, and iterative optimization methods, among others.

After the clustering analysis, the process advances to step 114, where the system arranges the identified clusters into a classification level. At this step, the system creates a level of classification to discriminate between the identified clusters using the selected features. The process then progress to step 116, where the system determines if any of the clusters contain multiple output classes. If one or more clusters with multiple output classes are found, the classes within each cluster are poorly separated in feature space, and it is necessary to arrange the output classes within the clusters into at least one additional sublevel. Accordingly, the process returns to step 104, to begin processes the clusters containing multiple classes.

If all of the clusters contain only one output class, the classes are already well separated in the defined feature space. The system then progresses to step 120, where the generated classification architecture is accepted by the system. The process terminates at step 122.

FIG. 5 illustrates an example embodiment of a postal indicia recognition system 150 incorporating the present invention. A selection portion 152 selects features that will be useful in distinguishing between the output classes represented by the classifier. The selected features can be literally any values derived from the pattern that vary sufficiently among the various output classes to serve as a basis for discriminating among them. Generally, the features are selected at the time a classification architecture is established. Feature selection can be accomplished by a number of means, including human selection, automated selection processes, or even simple trial and error. In the preferred embodiment, features are selected by an automated process using a genetic clustering algorithm.

In the preferred embodiment of a postal indicia recognition system, example features include a histogram variable set containing sixteen histogram feature values, and a downscaled feature set, containing sixteen “Scaled 16” feature values.

A scanned grayscale image consists of a number of individual pixels, each possessing an individual level of brightness, or grayscale value. The histogram feature variables focus on the grayscale value of the individual pixels within the image. Each of the sixteen histogram variables represents a range of grayscale values. The values for the histogram feature variables are derived from a count of the number of pixels within the image having a grayscale value within each range. By way of example, the first histogram feature variable might represent the number of pixels falling within the lightest sixteenth of the range all possible grayscale values.

The “Scaled 16” variables represent the average grayscale values of the pixels within sixteen preselected areas of the image. By way of example, the sixteen areas may be defined by a four by four equally spaced grid superimposed across the image. Thus, the first variable would represent the average or summed value of the pixels within the extreme upper left region of the grid.

At the preprocessing portion 154, an input image is obtained and extraneous portions of the image are eliminated. In the example embodiment, the system locates any potential postal indicia within the envelope image. The image is segmented to isolate the postal indicia into separate images and extraneous portions of the segmented images are cropped. Any rotation of the image is corrected to a standard orientation. The preprocessing portion 154 then creates an image representation of reduced size to facilitate feature extraction.

The preprocessed pattern segment is then passed to a feature extraction portion 156. The feature extraction portion 156 analyzes the selected features of the pattern and assigns numerical values to them.

A clustering portion 158 analyses the extracted data to determine if any of the output classes are not well separated in feature space. The clustering analysis can take place via any number of methods, depending on the number of levels of classification expected or desired, the time necessary for classification at each iteration, and the number of output classes represented by the classifier. Perhaps the simplest approach is a single pass method. In one application of the single pass method, all of the classes are compared to all existing clusters in a random order. Classes within a threshold distance of an average point of an existing cluster are grouped with that cluster. The cluster is then revised to reflect the addition of the new class. Clusters that are not within the threshold distance of a cluster form new clusters.

In the example embodiment, a Kohonen algorithm is applied to group the classes. Each of N output classes is represented by a vector containing as its elements the mean feature value for each of the features used by the classifier. The clustering process begins with a distance determination among each of these class representative vectors in a training set.

In the Kohonen algorithm, a map is formed with a number of discrete units. Associated with each unit is a weight vector, initially consisting of random values. Each of the class representative vectors is inputted into the Kohonen map as a training vector. Units respond more or less to the input vector according to the correlation between the input vector and the unit's weight vector. The unit with the highest response to the input is allowed to learn, by changing its weight vector in accordance with the input, as are some other clusters in the neighborhood of the clusters. The neighborhood decreases in size during the training period.

The result of the training is that a pattern of organization emerges among the units. Different units learn to respond to different vectors in the input set, and units closer together will tend to respond to input vectors that resemble each other. When the training is finished, the set of class representative vectors is applied to the map once more, marking for each class the unit that responds the strongest (is most similar) to that input vector. Thus, each class becomes associated with a particular unit on the map, creating natural clusters of classes.

These natural clusters may be further grouped by combining map units that represent similar output classes. In an example embodiment, this is accomplished by a genetic clustering algorithm. Once the Kohonen clustering is established, it can be altered slightly, by combining or separating map units. For each clustering state, a metric is calculated to determine the utility of the clustering. This allows the system to select which clustering state is optimal for the selected application. Often, this metric is a function of the within groups variance of the clusters, such as the Fisher Discriminant Ratio. Such metrics are well known in the art.

In the example embodiment, the clustering portion 158 includes of a number of single class classification portions, each representing one of the output classes of interest. Each of these classifiers receives a number of known pattern samples to classify. Each classifier is assigned a cost function based upon the accuracy of its classification of the samples, and the time necessary to classify the samples. The cluster arrangement that produces the minimum value for this cost function is selected as the clustering state for the analysis.

The architecture organization portion 160 arranges the system architecture in accordance with the results of the clustering analysis. The clusters found in the clustering portion are arranged into a first level of classification, using the features selected in the feature selection portion to discriminate between the classes. A number of classifiers are available for use at each level, and different classifiers may be used in different sublevels of classification. In the example embodiment, a technique based on radial basis function networks is used for the classification stages. Common classification techniques based on radial basis functions should be well known to one skilled in the art.

For clusters found to contain more than one class, a sublevel of processing is created to aid the classification process. The organization process is repeated for each new sublevel, so a sublevel can have different selected features and sublevels of its own.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A method of automatically establishing a system architecture for a pattern recognition system with a plurality of output classes, comprising:
extracting feature data from a plurality of pattern samples corresponding to a selected set of feature variables;
applying a clustering algorithm to the extracted feature data to identify a plurality of clusters, including at least one cluster containing more than one output class;
arranging the identified clusters into a first level of classification that discriminates between the clusters using the selected set of feature variables; and
arranging the output classes within each cluster containing more than one output class into at least one sublevel of classification that discriminates between the output classes within the cluster using at least one alternate set of feature variables.

2. A method as set forth in claim 1, wherein the step of applying a clustering algorithm to the extracted feature data includes minimizing a cost function associated with a pattern recognition classifier.

3. A method as set forth in claim 1, wherein the step of applying a clustering algorithm to the extracted feature data includes minimizing a function of the within group variance of the plurality of clusters.

4. A method as set forth in claim 1, wherein the step of applying a clustering algorithm to the extracted feature data includes applying a single pass clustering algorithm.

5. A method as set forth in claim 1, wherein the step of applying a clustering algorithm to the extracted feature data includes applying a Kohonen clustering algorithm.

6. A method as set forth in claim 1, wherein the pattern samples include scanned images.

7. A method as set forth in claim 6, wherein at least one of the plurality of output classes represents a variety of postal indicia.

8. A method as set forth in claim 6, wherein at least one of the plurality of output classes represents an alphanumeric character.

9. A computer program product, operative in a data processing system, for automatically establishing a system architecture for a pattern recognition system with a plurality of output classes, comprising:
a feature extraction portion that extracts feature data from a plurality of pattern samples corresponding to a selected set of feature variables;
a clustering portion that applies a clustering algorithm to the extracted feature data to identify a plurality of clusters, including at least one cluster containing more than one output class;
an architecture organization portion that arranges the identified clusters into a first level of classification that discriminates between the clusters using the selected set of feature variables and arranges the output classes within each cluster containing more than one output class into at least one sublevel of classification that discriminates between the output classes within the cluster using at least one alternate set of feature variables.

10. A computer program product as set forth in claim 9, wherein the clustering algorithm applied to the extracted feature data minimizes a cost function associated with a pattern recognition classifier.

11. A computer program product as set forth in claim 9, wherein the clustering algorithm applied to the extracted feature data minimizes a function of the within group variance of the plurality of clusters.

12. A computer program product as set forth in claim 9, wherein the clustering portion applies a single pass clustering algorithm to the extracted feature data.

13. A computer program product as set forth in claim 9, wherein the clustering portion applies a Kohonen clustering algorithm to the extracted feature data.

14. A computer program product as set forth in claim 9, wherein the pattern samples include scanned images.

15. A computer program product as set forth in claim 14, wherein at least one of the plurality of output classes represents a variety of postal indicia.

16. A computer program product as set forth in claim 14, wherein at least one of the plurality of output classes represents an alphanumeric character.
